(19) United States
(12) Patent Application Publication
(10) Pub. No.: US 2026/0296647 A1
(43) Pub. Date: Oct. 1, 2026

(54) CLOSEOUT AND AIRCRAFT PASSENGER SEATING ARRANGEMENT

(71) Applicant: Safran Seats GB Limited, Cwmbran (GB)

(72) Inventors: Vikram Vhanmane, Cwmbran (GB); Mayur Kallabettu, Cwmbran (GB); Mark Hayward, Cwmbran (GB)

(21) Appl. No.: 19/478,142

(22) PCT Filed: Apr. 26, 2024
(86) PCT No.: PCT/GB2024/051112

§ 371 Date: Oct. 23, 2025

(30) Foreign Application Priority Data
Apr. 28, 2023 (GB) 2306371.2

(51) Int. Cl. B64D 11/06; B64C 1/18

(52) U.S. Cl. CPC B64D 11/064; B64C 1/18

(57) ABSTRACT

A closeout for covering a region of an aircraft passenger seating arrangement, the closeout comprising:
a first cover, comprising a flexible sheet;
a second cover, comprising a plurality of at least partially overlapping slats; and
a sliding mechanism supporting the first cover, such that the first cover is moveable between extended and retracted positions.

In the extended position, the first cover fully covers the region, and, in the retracted position, the first cover only partially covers said region.

The first cover is configured to be folded at least once in the retracted position.

The first cover is coupled to at least one of the slats of the second cover, such that
when the first cover is moved into the retracted position/extended position, the second cover is moved into a corresponding retracted position/extended position.

### FIELD OF THE INVENTION

The present invention concerns a closeout. More particularly, but not exclusively, this invention concerns a closeout for an aircraft passenger seating arrangement, comprising a first cover comprising a flexible sheet and a second cover comprising a plurality of at least partially overlapping slats. The invention also concerns an aircraft passenger seating arrangement.

### BACKGROUND OF THE INVENTION

It is now an expected feature of premium aircraft passenger seating arrangements that the seat of the aircraft passenger seating arrangement, and other parts of furniture within the aircraft passenger seating arrangement, are adjustable. The adjustable features of the aircraft passenger seating arrangement require various movement mechanisms, which need to be internal to the passenger seating arrangement structure, so that a passenger cannot accidentally, or deliberately, be hurt by or interfere with, the mechanism.

In addition, the mechanism needs to be kept free from foreign objects and debris, in order to continue to function well.

Closeouts therefore need to be able to move within the seat and the passenger seating arrangement, in such a way that they can expand and collapse, to accommodate movement of the aircraft furniture within the passenger seating arrangement.

Known closeout designs in the art include fabric-based closeouts that are mechanically attached to movable aircraft furniture at one end, and mechanically attached to a static part of the passenger seating arrangement at the other end, in a manner such that the mechanism remains located below the closeout.

In some known closeout designs, as the furniture moves, the fabric stretches to ensure the mechanism remains covered.

In other known closeout designs, as the furniture moves, the fabric is deployed from rolls over a spring-loaded reel to ensure the mechanism remains covered, in a manner not dissimilar to how a household window blind would operate.

However, such fabric-based designs are not particularly durable, and can easily be torn and/or otherwise damaged, leaving the mechanism exposed.

There is therefore a desire to provide a closeout that can expand and collapse, to accommodate movement of the aircraft furniture within the passenger seating arrangement, that is more durable and that can provide a more robust barrier to foreign objects, debris and/or passenger interference.

The present invention seeks to mitigate the above-mentioned problems and/or provide an improved closeout, and/or an imported aircraft passenger seating arrangement.

### SUMMARY OF THE INVENTION

According to a first aspect of the invention, there is provided a closeout for covering a region of an aircraft passenger seating arrangement, the closeout comprising:
a first cover, comprising a flexible sheet,
a second cover, comprising a plurality of at least partially overlapping slats, and
a sliding mechanism supporting the first cover such that the first cover is moveable between an extended position and a retracted position.
   According to the first aspect of the invention, in the extended position, the first cover is arranged to fully cover the region of an aircraft passenger seating arrangement, and, in the retracted position, the first cover only partially covers the region of an aircraft passenger seating arrangement.

In addition, the first cover may be coupled to at least one of the slats of the second cover such that, when the first cover is moved into the extended position, the second cover is moved into an extended position which fully covers the region of an aircraft passenger seating arrangement, and, when the first cover is moved into the retracted position, the second cover is moved into a retracted position which only partially covers the region of an aircraft passenger seating arrangement.

The flexible sheet of the first cover may be configured to be folded at least once in the retracted position.

The sliding mechanism may comprise a drive mechanism arranged to drive the first cover between the extended position and the retracted position.

Alternatively, the siding mechanism may not comprise a drive mechanism, and instead require force to be applied by an external movable element such as a movable passenger seat, or a movable door of an aircraft passenger seating arrangement.

An advantage of this configuration is that only no further drive mechanism, other than the mechanism used to drive the movement of the element, is required in order to move the closeout.

The present aspect of the invention advantageously only requires the first cover to be driven between the extended position and retracted position due to the coupling between the first cover and second cover. This reduces the number of parts that are required to operate the closeout. Alternatively, the sliding mechanism may comprise a drive mechanism arranged to drive the second cover between the extended position and the retracted position.

The first cover may be arranged to be moveable between the extended position and the retracted position along a longitudinal axis.

The sliding mechanism may be configured to constrain the first cover to linear movement, for example along one or more linear tracks.

The first cover may comprise a flexible fabric sheet. The fabric may be woven.

The flexible sheet of the first cover may be configured to be folded in a concertina in the retracted position.

The first cover may comprise at least one stiffening element. The first cover may comprise at least two stiffening elements.

The at least one (or two) stiffening element(s) may comprise one or more solid panel(s). The solid panels may be attached to, or housed within, the flexible sheet. The flexible sheet of the first cover may be configured to be folded, such that the at least two of the solid panels are arranged such that their faces are at a non-zero angle to the longitudinal axis. The solid panels may repeat periodically across the flexible sheet along the longitudinal axis when the first cover is in the extended position.

The at least two stiffening elements each may be a solid panel. The flexible sheet of the first cover may be configured to be folded in the retracted position, such that at least two of the solid panels are arranged such that their faces are substantially perpendicular to the longitudinal axis.

The flexible sheet of the first cover may be arranged to be substantially flat in the extended position. In such a position, the plurality of stiffening elements (or solid panels) may be arranged in a periodically repeating pattern.

The second cover may comprise an inside face, configured to be adjacent to the region to be covered, and an outside face, configured to be adjacent to the first cover. This configuration has the advantage that the second cover is protected by the first cover, for example, it stops passengers from placing their fingers in between the plurality of slats. Each of the plurality of slats may have a length, wherein the length of the slats is perpendicular to the movement axis.

Each of the plurality of slats may comprise, with reference to the length of the slat, at least one edge, optionally at least one swept edge, located towards an end, optionally a distal end, of the slat. Optionally, each of the plurality of slats may comprise two edges, with reference to the length of the slat, a first edge, particularly a first swept edge, located towards a first distal end of the slat and a second edge, optionally a second swept edge located at a second distal end of the slat. Edges may allow for smoother movement of the slats along the movement axis.

The plurality of slats of the second cover may be formed of polymer, composite, metal material, or natural material such as wood or cardboard.

The first cover may be coupled to at least one of the plurality of slats by a reversible fastener. The first cover may be coupled to more than one of the plurality of slats by a reversible fastener mounted to each of the than one of the plurality of slats. The first cover may be coupled to substantially all of the plurality of slats by a reversible fastener mounted to substantially all of the than one of the plurality of slats. The reversible fastener may comprise a hook and loop-type fastener and/or a popper-type fastener. Coupling the first cover to substantially all of the plurality of slats has the advantage that all of the slats are supported, and that that all of the slats are driven individually by movement of the first cover.

The slide mechanism may comprise at least one guide rail, arranged to support and/or constrain the movement of the slats of the second cover. The closeout may comprise a plurality of guide rails arranged to support and/or constrain the movement of the slats of the second cover. The one or more guide rails may be arranged to constrain the movement of the slats to a linear movement. The plurality of overlapping slats may be moulded, such that they can engage with the one or more guide rails.

Alternatively or additionally, the closeout may comprise a plurality of guide supports configured to support the slats. The plurality of guide supports may be positioned, such that they support each of the slats towards each end of the slats, with reference to the length of the slat. The guide supports may be configured to support the edges of each of the slats.

According to a second aspect of the invention, there is provided an aircraft passenger seating arrangement comprising a region to be covered, and a closeout according to the first aspect of the invention, wherein the closeout is arranged such that
when the first cover is in the extended position, the region to be covered is fully covered by the first cover, and
when the first cover is in retracted position, the region to be covered is only partially covered by the first cover.

The aircraft passenger seating arrangement may comprise an aircraft seat with moveable element, such as a seat pan and/or backrest. The region to be covered may not be covered by the moveable element, when the first cover is in the extended position, and the region to be covered may be partially covered by the moveable element when the first cover is in the retracted position.

The aircraft seat may be mounted for translation on the sliding mechanism along the movement axis between a first position and second positon. The first position may correspond to a rearmost position and the second position may correspond to a foremost position.

The aircraft passenger seating arrangement may further comprise a static part of the aircraft passenger seating arrangement adjacent to the region to be covered, such as a wall portion and/or a floor portion of the aircraft passenger seating arrangement.

A first portion of the first cover may be mounted to the movable element, and a second portion of the first cover may be mounted to the static part of the aircraft passenger seating arrangement.

The first cover may be moved between the retracted position and extended position, by moving the movable element between the first position and the second positon. The drive mechanism may be arranged to drive the first cover between the extended position and the retracted position, via indirectly driving the first cover by driving the movable element.

There may be a mechanism, for example, a drive mechanism, located within the region to be covered.

The drive mechanism may be configured to drive the movable element.

The first end of the closeout may be coupled to the aircraft seat and the second end of the closeout may be coupled to a portion of the floor area of the aircraft seat.

The first end of the closeout may comprise a part of the first cover for mounting to a part of a seat. The second end of the closeout may comprise a mounting plate for mounting to a floor of an aircraft passenger seating arrangement. This advantageously allows the closeout to be driven by movement of the seat forwards, which results in pulling forward the part of the first end of the closeout that is attached to the seat. As the first cover is also coupled to the second cover, the second cover is also pulled, when the first cover moves forward with the seat. This means that the closeout can be driven by the same mechanism that is used to drive the seat.

It will of course be appreciated that features described in relation to one aspect of the present invention may be incorporated into other aspects of the present invention. For example, the closeout according to the first aspect of the invention may incorporate any of the features described with reference to the aircraft passenger seating arrangement according to the second aspect of the invention and vice versa.

### DESCRIPTION OF THE DRAWINGS

Embodiments of the present invention will now be described in detail, by way of non-limiting examples. The present invention is not limited to the disclosures that follow, which are provided only in order to aide understanding of the invention, with reference to the accompanying schematic drawings of which:

FIG. 1 shows an aircraft passenger seating arrangement in accordance with an embodiment of the invention having a closeout and a moveable aircraft seat, where only a bottom cover of the closeout is shown for clarity, and wherein the closeout is shown in a retracted position;

FIG. 2 shows the aircraft passenger seating arrangement in accordance with the embodiment of the invention, where only a bottom cover of the closeout is shown for clarity, and wherein the closeout is shown in an extended position;

FIG. 3 shows the closeout in accordance with the embodiment of the invention in the extended position, wherein the top cover and bottom cover of the closeout are shown;

FIG. 4 shows the closeout in accordance with the embodiment of the invention in the retracted position, wherein the top cover and bottom cover of the closeout are shown;

FIG. 5 shows the closeout in accordance with the embodiment in the extended position, wherein the top cover and bottom cover of the closeout are shown from a side-on view;

FIG. 6 shows a closeout in accordance with the embodiment of the invention in the retracted position, wherein the top cover of the closeout are shown from a side-on view, and wherein the bottom cover is not shown for clarity;

FIG. 7 shows the aircraft passenger seating arrangement in accordance with the embodiment of the invention, where the top and bottom covers of the closeout are shown, and wherein the closeout is shown in a retracted position; and

FIG. 8 shows the aircraft passenger seating arrangement in accordance with the embodiment of the invention, where the top and bottom covers of the closeout are shown, and wherein the closeout is shown in an extended position.

### DETAILED DESCRIPTION

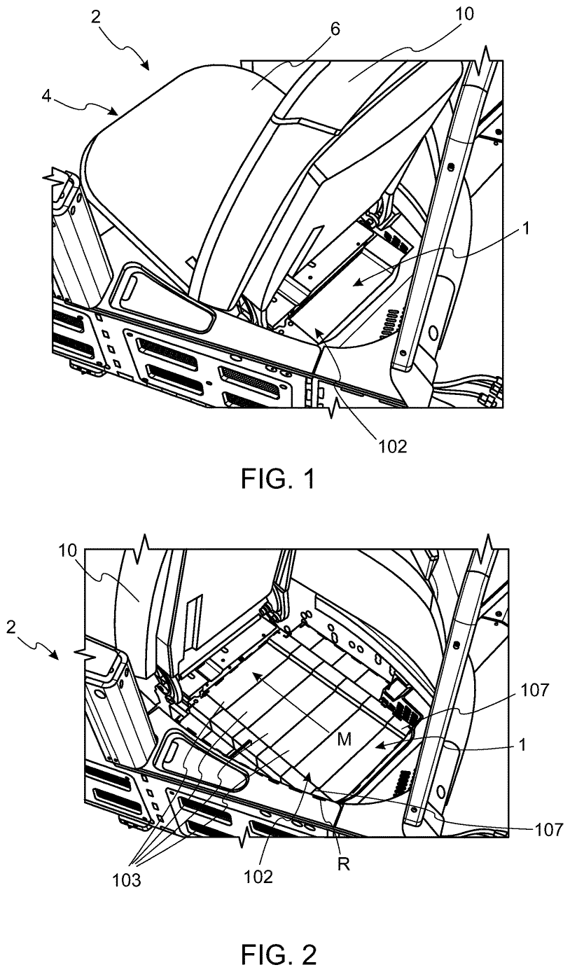

A closeout 1 according to an embodiment of the invention is now described with reference to FIGS. 1 to 8.

The closeout 1 is shown in FIG. 1 and FIG. 2 within a passenger seating arrangement 2, particularly a passenger seating arrangement 2 located in an aircraft. The passenger seating arrangement 2 includes a seat 4, which may have a seat pan 6 and a seat backrest 10.

The closeout 1 is located to a rear of the seat back 10. The view in accordance with in FIG. 1 of the closeout 1 only shows a bottom cover 102. According to the invention, the bottom cover 102 is formed of a plurality of overlapping slats 103, which can be seen on FIG. 2.

Specifically, FIG. 1 shows the aircraft passenger seating arrangement 2 where the closeout 1 is shown in a retracted position and FIG. 2 shows the aircraft passenger seating arrangement 2 where the closeout 1 is shown in an extended position;

The closeout 1 may also include an additional fabric cover configured to be placed on top of the bottom cover 102. The additional fabric cover is not shown in FIGS. 1 and 2 for clarity in order to ease the description of the workings of the slats 103.

According to a particular embodiment of the invention, the plurality of slats 103 are stackable.

The plurality of slats 103 may be made of a polymer material.

The bottom cover 102 can take
a retracted position, where all of the plurality of slats 103 are stacked on top of each other, and
an extended position, where all of the plurality of slats 103 are overlapping at their edge, such that a region R, located behind the seat 4 (and behind the seat back 10), is covered.

The plurality of overlapping slats 103 unfurl, when they are moved to the extended position, particularly along a linear movement according to a longitudinal axis M, such that the entirety of the region R, located behind the seat 4, particular behind the seat backrest 10, is covered.

The slats 103 rest at least one guiding rail 107, particularly on two guiding rails 107. This helps ensure that the plurality of slats 103 only move along the longitudinal axis M, and provides stability as they move.

The seat 4, the plurality of slats 103 and the guiding rail 107 are all supported on a floor of the passenger seating arrangement 2.

The seat pan 6 and the seat backrest 10 are movable and may be independently mounted on the floor of the passenger seating arrangement 2 by the guiding rail 107, and are configured for linear movement along the guiding rail 107 between a foremost position, as shown in FIG. 2; and a rearward position, as shown in FIG. 1.

A drive mechanism, particularly an electronic drive mechanism, which can drive the seat 4, is not shown, but is located under the region R, located behind the seat 4.

The closeout 1 covers the drive mechanism, and the region R, located behind the seat 4, when the seat 4 is in the foremost position or in any positions between the foremost position and the rearward position.

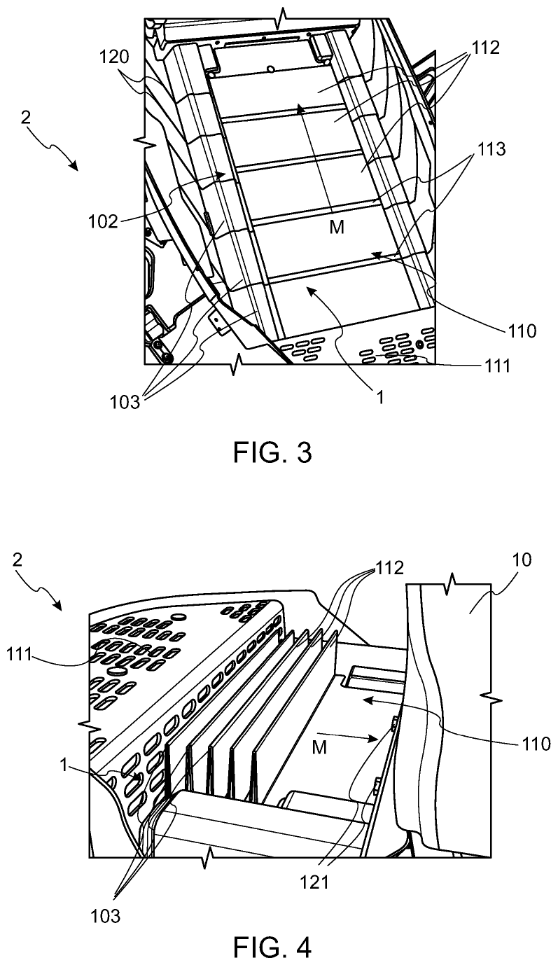

FIG. 3 shows the closeout 1 as previously described, in accordance with the embodiment of the invention in the extended position, where a top cover 110 is shown. In addition, on FIG. 3, part of the furniture of the aircraft passenger seating arrangement 2 has been removed, such that the distal ends of the each of the plurality of slats 103 of the bottom cover 102 are shown. Moreover, for clarity, not every element of FIG. 1 or 2 are shown or labelled in FIG. 3. The aircraft seat 4 is also removed.

The top cover 110 is coupled to each of the slats 103 of the bottom cover 102 by a reversible fastener that is not shown.

The top cover 110 is shown in an extended position, and the bottom cover 102 is also shown in an extended position. The top cover 110 does not cover all of the bottom cover 102, and only covers a central portion of the bottom cover 102.

Instead, the top cover 110 may be made of fabric and may comprise a plurality of rigid structural panels 112 embedded within the flexible fabric top 110. The rigid structural panels 112, for instance formed of polymer material.

The rigid structural panels 112, when the top cover 110 is in the extended position, span a large proportion of the surface area of the top cover 110, but leave a number of fabric joins 113 between the rigid structural panels 112, that allow the top cover 110 to fold.

The plurality of slats 103 of the bottom cover 102 have edges 120, particularly swept edges 120, at their distal ends.

A mounting plate 111 of the closeout 1 is present at one end of the closeout 1 for attaching to a floor of an aircraft passenger seating arrangement 2.

FIG. 4 shows the closeout 1 as in FIG. 3, in accordance with the embodiment of the invention in the retracted position, but from a side view. In FIG. 3, the seat backrest 10 is also shown.

Similarly, for clarity, not every element of FIG. 1, 2 or 3 are shown or labelled in FIG. 4.

However, on FIG. 4, the top cover 110 is shown in a retracted position, and the bottom cover 102 is not visible, in view of being obscured by the top cover.

In the retracted position, the plurality of rigid structural panels 113 are folded about fabric joins 113, such that they may be perpendicular to the longitudinal axis M. This kind of fold can be described as a concertina fold.

Mounting bolts 121 are attached at one end of the top cover 110 to allow it to be attached to the seat backrest 10 of the seat 4.

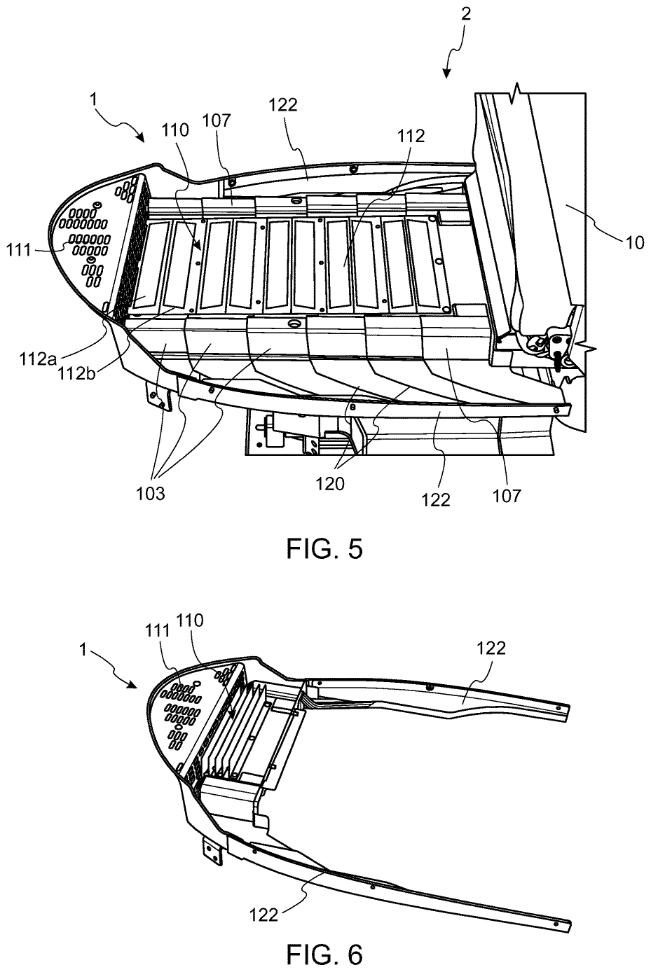

FIG. 5 shows the closeout 1 as in FIG. 4, in accordance with the embodiment in the extended position, but from a different view.

In this view, the mounting plate 111 may comprise guide supports 122. The guide supports 122 are located parallel to, and to the outside of, the guiding rails 107. The guide supports 122 support the edges 120 of each of the plurality of slats 103.

Thus, the slats 103 may have a moulded design that is moulded to the guiding rails 107.

The rigid structural panels 112 are shown in more detail, and are depicted as having two halves 112a, 112b, that can fold against each other in a concertina fold.

FIG. 6 shows the closeout 1 as in FIG. 4, in accordance with the embodiment of the invention in the retracted position, but from another different view, where the bottom cover 102 is not shown, nor is the seat back 4.

The top cover 110 is shown in its retracted position such that the structural panels 112 are folded together in a concertina fold.

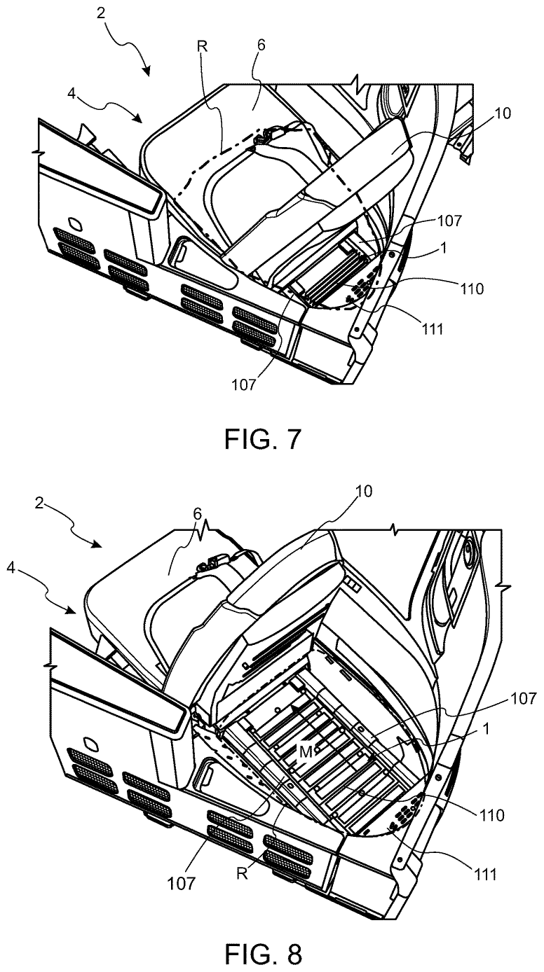

FIGS. 7 and 8 show the passenger seating arrangement 2 from a bird's eye view, where all of the components are included such that the closeout 1 is shown as it would be used on an aircraft suite 2 in practice.

FIG. 7 shows the closeout 1 in a retracted position and the seat 4 in a rearmost position. In this position,
the seat 4 is positioned at a point along the guiding rails 107, such that it is close to a perimeter wall of the passenger seating arrangement 2,
the top cover 110 is in its retracted position, as previously described,
part of the region R, located behind the seat 4, is covered by the top cover 110 and the bottom cover 102 that is not visible, and
part of the region R, located behind the seat 4, is covered by the seat pan 6 and seat backrest 10 of the seat 4.

FIG. 8 shows the closeout 1 in an extended position and the seat 4 in a foremost position. In this position,
the seat 4 is positioned at a point along the guiding rails 107, such that it is distal from a perimeter wall of the passenger seating arrangement 2,
the top cover 110 is in its extended position, as previously described,
substantially all of the region R, located behind the seat 4, is covered by the top cover 110 and the bottom cover 102 that is not visible.

The movement of the seat 4 between the rearmost position shown in FIG. 7 and the foremost position shown in FIG. 8 along the longitudinal axis M, will now be described.

A drive mechanism, not shown, located within the region R, located behind the seat 4, drives the seat 4 forward along the longitudinal axis M. When the seat 4 is driven forward, the top cover 110 unfolds from its retracted position and moves towards its extended position along the longitudinal axis M, because of its coupling to the seat back 10, which is now moving forward. Due to the coupling between the top cover 110 and the slats 103 of the bottom cover 102, the bottom cover 102 also extends along the longitudinal axis M. When the seat 4 reaches its foremost position, both the bottom cover 102 and the top cover 110 are in their extended positions. The movement of the seat 4 between the foremost position shown in FIG. 8 and the rearmost position shown in FIG. 7 is simply the reverse of what has previously been described.

Thus, it can be seen that the closeout 1 can be moved between a retracted position as shown in FIGS. 1, 4, 6 and 7 and an extended position as shown in FIGS. 2, 3, 5 and 8, with the slats 103 unfurling/stacking and the top cover 110 folding/unfolding as required to ensure that the region R, located behind the seat 4, remains covered, and thus protected in a durable and robust manner, throughout movement of the seat 4 between its foremost and rearmost positions.

In the embodiment shown in the drawings, the top cover 110 of the closeout 1 is configured to take a concertina fold in the retracted position. The skilled person will be able to readily envisage further embodiments where the top cover 110 folds in different ways, such as, for example, in ways found in origami folding techniques.

In the embodiment shown in the drawings, the top cover 110 of the closeout 1 is configured to be folded such that the plurality of rigid structural panels 112 are folded about fabric joins 113, such that they are perpendicular to the longitudinal axis M. The skilled person will be able to readily envisage further embodiments where the top cover 110 folds in different ways, for example such that the rigid structural panels 113 are at a non-zero angle to the longitudinal axis M other than a substantially perpendicular angle.

In the embodiment shown in the drawings, the closeout 1 is configured to cover a region, or aperture, behind a moveable seat 4. The skilled person will be able to readily envisage further embodiments where the closeout 1 is configured to close different regions, such as window openings or storage openings, or mechanisms adjacent to or behind moving doors, ottomans or other movable elements or pieces of aircraft furniture.

In the embodiment shown in the drawings, the rigid structural panels 112 and plurality of slats 103 are formed of polymer material. The skilled person will be able to readily envisage further embodiments where the structural panels 113 and/or plurality of slats 103 are formed of other suitable materials, such as composites, metals, including metal alloys, and or natural materials such as wood, or cardboard.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents.

It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A closeout for covering a region of an aircraft passenger seating arrangement, the closeout comprising:
a first cover, comprising a flexible sheet;
a second cover, comprising a plurality of at least partially overlapping slats, and
a sliding mechanism supporting the first cover, such that the first cover is moveable between an extended position and a retracted position,
wherein,
in the extended position, the first cover is arranged to fully cover the region of an aircraft passenger seating arrangement, and
in the retracted position, the first cover only partially covers the region of an aircraft passenger seating arrangement,
wherein the first cover is configured to be folded at least once in the retracted position, and
wherein the first cover is coupled to at least one of the slats of the second cover, such that,
when the first cover is moved into the extended position, the second cover is moved into an extended position, which fully covers the region of the aircraft passenger seating arrangement, and
when the first cover is moved into the retracted position, the second cover is moved into a retracted position, which only partially covers the region of the aircraft passenger seating arrangement.

2. A closeout for covering a region of an aircraft passenger seating arrangement as claimed in claim 1, wherein the first cover comprises a flexible fabric sheet.

3. A closeout for covering a region of an aircraft passenger seating arrangement as claimed in claim 1, wherein the first cover is arranged to be moveable between the extended position and retracted position along a longitudinal axis.

4. A closeout for covering a region of an aircraft passenger seating arrangement as claimed in claim 1, wherein the flexible sheet of the first cover is configured to be folded in a concertina in the retracted position.

5. A closeout for covering a region of an aircraft passenger seating arrangement as claimed in claim 1, wherein the first cover comprises at least one stiffening element.

6. A closeout for covering a region of an aircraft passenger seating arrangement as claimed in claim 5, wherein the at least one stiffening element comprises solid panels attached to, or housed within, the flexible sheet.

7. A closeout for covering a region of an aircraft passenger seating arrangement as claimed in claim 6, wherein the first cover comprises at least two stiffening elements, each of the at least two stiffening elements being a solid panel, and wherein, in the retracted position, the flexible sheet of the first cover is configured to be folded, such that at least two of the solid panels are arranged such that faces of the at least two solid panels are substantially perpendicular to a longitudinal axis along which the first cover is moveable between the extended position and retracted position.

8. A closeout for covering a region of an aircraft passenger seating arrangement as claimed in claim 1, wherein the second cover comprises an inside face, configured to be adjacent to the region, and an outside face, configured to be adjacent to the first cover.

9. A closeout for covering a region of an aircraft passenger seating arrangement as claimed in claim 1, wherein the slats comprise, with reference to the length of the slat, at least one edge, optionally at least one swept edge, said swept edge being located towards an end of the slat.

10. A closeout for covering a region of an aircraft passenger seating arrangement as claimed in claim 1, wherein the first cover is coupled to at least one of the plurality of slats by a reversible fastener.

11. A closeout for covering a region of an aircraft passenger seating arrangement as claimed in claim 1, wherein the slide mechanism comprises a guide rail arranged to support and/or constrain the movement of the slats of the second cover.

12. A closeout for covering a region of an aircraft passenger seating arrangement as claimed in claim 1, wherein the closeout comprises a plurality of guide supports configured to support the slats and positioned such that guide supports support each of the slats towards, with reference to their length, their ends.

13. An aircraft passenger seating arrangement comprising a region to be covered, and a closeout according to claim 1, wherein the closeout is arranged such that
when the first cover is in the extended position, the region is fully covered by the first cover, and
when the first cover is in retracted position, the region is only partially covered by the first cover.

14. An aircraft passenger seating arrangement as claimed in claim 13, wherein the aircraft passenger seating arrangement further comprises an aircraft seat with moveable element, such as a seat pan and/or backrest,
wherein
the region is not covered by the moveable element, when the first cover is in the extended position, and
the region is partially covered by the moveable element, when the first cover is in the retracted position.

15. An aircraft passenger seating arrangement as claimed in claim 14, wherein a first portion of the first cover is mounted to the movable element, and a second portion of the first cover is mounted to a static part of the passenger seating arrangement.
